(19) United States
(12) Patent Application Publication
(10) Pub. No.: US 2010/0243553 A1
(43) Pub. Date: Sep. 30, 2010

(54) DEVICE FOR TREATING RAIN WATER

(76) Inventor: Albert Vuilliomenet, Blonay (CH)

Correspondence Address: NIXON & VANDERHYE, PC, 901 NORTH GLEBE ROAD, 11TH FLOOR, ARLINGTON, VA, 22203, US

(21) Appl. No.: 12/744,279

(22) PCT Filed: Nov. 5, 2008
(86) PCT No.: PCT/IB08/54610

§ 371 Date: Jun. 3, 2010

(30) Foreign Application Priority Data
Nov. 25, 2007 (IB) PCT/IB2007/054777

(51) Int. Cl. C02F 1/00

(52) U.S. Cl. 210/435

(57) ABSTRACT

The invention relates to a device for treating rain water that comprises a housing (4) adapted to be vertically inserted into a dump-separator (1), said dump-separator (1) including a water inlet (2) and a water outlet (12), characterized in that a portion of the side wall of the housing (4) is at least partially curved, and in that said portion includes a filter (5), the inside of the housing (4) being formed by first (6) and second (8) chambers separated by a vertical wall (9) but communicating with each other via a passage (15) formed in the lower portion of the housing (4), said filter (5) defining the outer side wall of the first chamber (6), and the second chamber (8) including an outlet opening adapted for direct communication, via a discharge pipe (7), with said water outlet (12) of the dump-separator (1).

### FIELD OF THE INVENTION

The present invention relates to the treatment of rain water, particularly in an urban environment. It relates more precisely to the extraction of sediments, of hydrocarbons and other similar elements that are to be separated from the rain water.

### PRIOR ART

Various devices are known that are used for the treatment of rain water. See for example patent documents WO 2007/011864, U.S. Pat. No. 6,780,310, EP 0 928 861 A1 and U.S. Pat. No. 5,814,216.

Another existing system consists of two basins placed in line.

The first basin is a decanter placed upstream of the hydrocarbon separator, provided at its inlet with a wall that slopes downward and in which the liquid flows horizontally. Due to the slowed flow, the heavy materials decant into the basin. Usual transit time: 120-150 s.

The second basin is a separator with enhanced effect, provided at its inlet and its outlet with a wall that slopes downward and in the line of the flow of a coalescing filter. The liquid flows horizontally. Because of the slowed flow, the light substances rise in the oil-collecting chamber and the heavy materials decant into the sludge chamber. The retention time usually varies between 90 and 300 sec.

### SUMMARY OF THE INVENTION

The subject of the present invention is an enhanced device for the treatment of rain water, which device makes it possible to extract elements of varied shapes and types such as sediments, hydrocarbons, floating bodies, etc.

The device according to the invention comprises an enclosure adapted to be inserted vertically into a sump-separator. The sump-separator comprises a water inlet and a water outlet. The device according to the invention is characterized in that a portion of the lateral wall of the enclosure is at least partially curved and that said portion comprises a filter. The inside of the enclosure is formed by a first cavity and a second cavity separated by a vertical wall but communicating with one another by means of an orifice created in the lower portion of the enclosure. The first cavity has said filter as its outer lateral wall. The second cavity comprises an outlet orifice suitable for communicating directly with said water outlet of the sump-separator.

According to one embodiment of the invention, the device comprises: a first enclosure of substantially cylindrical shape and a second enclosure also of substantially cylindrical shape placed concentrically inside the first enclosure. A water intake orifice is attached to or formed integrally with the first enclosure.

The second enclosure is formed by two half-cylinders separated by a common wall which however makes it possible to create a communication orifice between the two half-cylinders, in its lower portion. The substantially cylindrical outer wall of one of the two half-cylinders consists of a sealed surface in its lower portion and of a permeable surface (filter) in its upper portion. The outer wall of the other half-cylinder is impermeable; a water discharge orifice is attached to or formed integrally with the outer wall of this half-cylinder.

With the device according to the invention, operations of sedimentation, decantation and separation are carried out in a single sump-separator.

It is also appropriate to emphasize one of the particular advantages provided by the present invention, namely that the operations of separation, decantation and sedimentation are adapted to the incoming flow rates.

Although the device according to the invention is designed to initiate a laminary flow of the water, turbulence may however occur in cases of heavy showers.

The operation of the device is however ensured, irrespective of the type of flow.

### DETAILED DESCRIPTION OF THE INVENTION

The invention will be better understood below by means of a detailed description containing examples illustrated by the following figures:

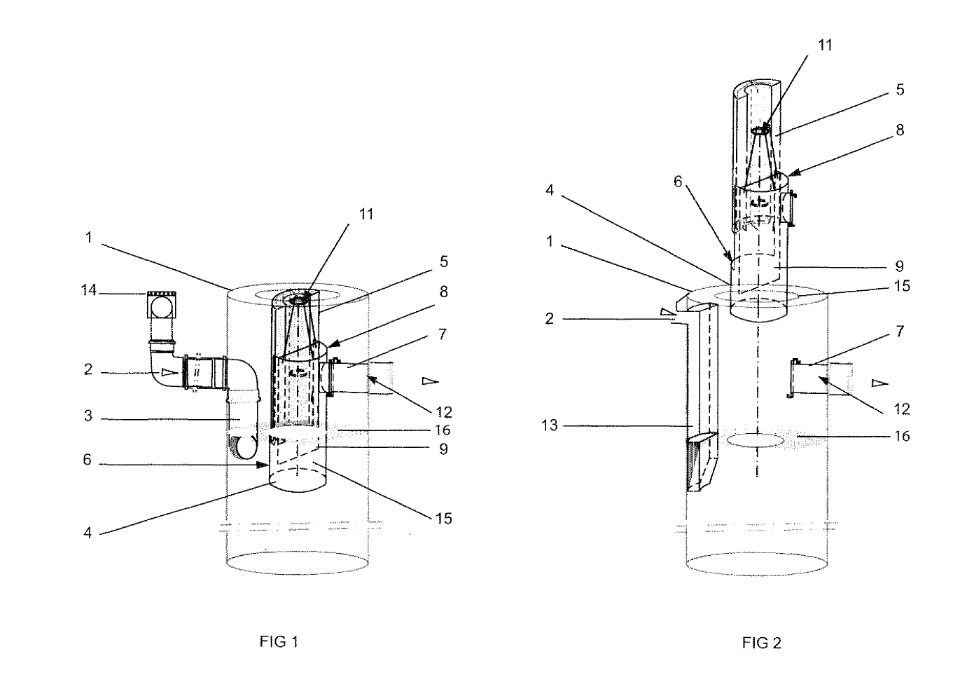

FIG. 1 represents a first embodiment of a device according to the invention.

FIG. 2 represents a second embodiment of a device according to the invention.

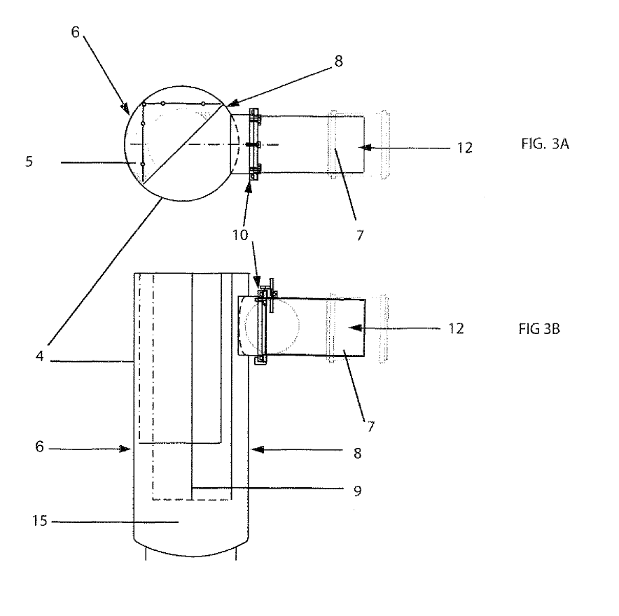

FIGS. 3A and 3B represent respectively a top view and a front view of an enclosure that can be used in the devices of FIGS. 1 and 2.

### REFERENCE NUMBERS USED IN THE FIGURES

1. Sump-separator
2. Water inlet
3. Chicane
4. Enclosure
5. Filter
6. 1st half-cylinder
7. Discharge tube
8. 2nd half-cylinder
9. Separation wall
10. Flange
11. Gripping member
12. Water outlet
13. Chicane
14. Grating
15. Passage
16. Supernatant trap

As can be seen in FIG. 1, a tubular-shaped inlet chicane 3, connected to a water inlet 2, itself connected to a grating 14, directs the tangential penetration of the liquid into a sump-separator 1 in the shape of a cylindrical tank. The sump-separator 1 also comprises a water outlet 12.

An enclosure 4 of substantially cylindrical shape is placed vertically and coaxially inside the sump-separator 1. A portion of the wall of the enclosure 4 is formed by a filter 5. The enclosure 4 consists of two half-cylinders 6, 8 each forming a cavity, the two cavities 6, 8 being separated by a wall 9 that is vertical and sealed but of which the lower portion comprises a passage 15 connecting the two cavities 6, 8. The outer wall of the first cavity 6 is formed by the filter 5, the second cavity comprising a discharge tube 7 which communicates directly with the outlet 12 of the sump-separator 1.

A supernatant trap 16, in the form of a circular grating with fine meshes (preferably smaller than 5 mm), is placed around the two half-cylinders 6, 8 so as to join respectively its inner edge with the walls of the half-cylinders 6, 8 and its outer edge with the inner wall of the sump-separator 1. The supernatant trap 16 preferably consists of a synthetic material but any other appropriate material may be used.

More precisely, the supernatant trap 16 is preferably placed just beneath the lower level of the filter 5 and above the water inlet 2. Its aim is to prevent the accidental clogging of the filter 5 by floating objects, whether or not degradable, of a density of generally less than 1, such as for example tree leaves, conifer needles or cigarette butts.

The upper portion of the enclosure 4 is furnished with a gripping member 11 comprising an assembly of rods and a ring. The gripping member 11 makes it easier to remove the enclosure 4. On this subject, see FIG. 2 which illustrates a position in which the enclosure 4 is removed from the sump-separator 1.

The system illustrated in FIG. 2 is identical to that of FIG. 1. It differs only in the type of inlet chicane 13 which has a nontubular cross section. The liquid that comes out of the chicane 3, 13 makes a circular movement along the inner wall of the sump-separator 1 and contacts the filter 5 tangentially, over the whole of its surface. The speed and the direction followed by the liquid depend on the height of the water inlet column, preferably at least 70 cm, on the flow rate and on the geometry of the inlet chicane 3.

As it moves, the liquid is spread around the enclosure 4, along its outer lateral surface. This trajectory of the liquid has the effect of inducing an increase in the retention period. The particles in suspension have more time to be decanted according to their respective densities.

The enclosure 4 is completely closed at the bottom and closed at the top, but only above the second cavity 8. In summary, the second cavity 8 is closed and comprises only two passages 15, 7, the first 15 communicating with the first cavity 6, the second 7 with the outlet 2 of the sump-separator 1. The supernatant trap 16 forms the first element of separation which decants heavy and light materials. Once sedimented, they are deposited in the sludge chamber, at the bottom of the sump-separator 1. The light substances rise to the surface.

The filter 5, for example made of polyether foam, is preferably removable and mounted on a support. It provides a separation phase for the light substances then, via a filtration of the liquid, the enhanced separation effect.

Advantageously, the filter 5 is coalescing. By its structure (dimensions and arrangement of the pores), it thus forces liquid particles, usually hydrocarbon particles, to join together and form larger droplets, which droplets are separated by gravity.

In this way, the oil and the hydrocarbons in dispersion are captured by the filter 5.

Note moreover that the floating objects of a relatively large size are also retained by the filter 5.

Another important aspect is that the filter 5, via its considerable developed surface area and its vertical position, promotes the penetration of the liquid without disturbing it (laminary system), which has the effect of improving the efficiency of separation.

Inside the enclosure 4, the wall 9 which separates the two cavities 6, 8 is judiciously dimensioned so as to perform a second phase of decantation and separation applied to the liquid that has passed through the filter 5.

More precisely, the large droplets formed by coalescence (hydrocarbons or other oily components) which are in the first cavity 6 are directed by gravity to the top of the latter. Since the passage 15 connecting the two cavities 6, 8 is created in the lower portion of the enclosure 4, the large droplets are confined (trapped) in the first cavity. Therefore, only a treated liquid is allowed to enter the second cavity and then to use the outlet 7, 12 of the sump-separator 1.

Note that the volume of the liquid inside the enclosure 4 is determined by the downward-sloping height of the inlet chicane 3, 13.

The volume of the liquid inside the sump-separator 1 is, for its part, determined by the height of the water outlet 7, 12.

Advantageously (see FIGS. 3A and 3B), the enclosure 4 is a removable construction suspended from the discharge tube 7 by a flange 10 furnished with an O-ring seal made of nitrile rubber, with a spontaneous seal and two keys.

Preferably, a sealed orifice is created toward the discharge tube 7 in order to allow samples to be taken. Alternatively, the sealed orifice can be replaced by an automatic-closing butterfly valve.

The device according to the invention and its component parts can be made of any material making it possible to achieve the desired objective. The sealed walls of the enclosure 4 may advantageously be made of titanium-stabilized stainless steel.

The device according to the invention can be designed for various flow rates, for example less than 2 1/sec or more than 25 1/sec.

The use of the device according to the invention has shown the following results for a flow rate varying between 1 and 22 1/sec:
Suspended solids trapped >98%
Heavy metals are deposited in the sludge
Tested on test bench: hydrocarbons <5 mg/1
Significant reduction in dissolved heavy metals.

The present invention makes it possible:
to confine and treat at source the pollution of rain water in roadside drainage sumps, manholes, bags, roadside gulleys and gulleys in parking areas, and covered driving areas,
to ease the passage of discharging water from the unitary system to the separator,
to reduce the inflow of water at the treatment plants, improves treatment and consequently reduces treatment costs,
to choose the nearest existing wastewater outfalls: direct infiltrations into groundwater tables revitalizing them, connections to the drainage channels, embayments, streams, surface-water collectors, ponds, lakes.
to reduce the suspended solids, no deposit in the discharge works,
to reduce maintenance costs,
to achieve a better distribution and better control of overflows on the territory of the water disposal general plan (PGEE),
to prevent the construction of diversion drainage ditches, of large separators, of ponds or basins for the treatment of road water, of flood spillways, and of flow restrictors, and to remove the pollutant loads,
to reduce water stress,
to improve the oxidation of biodegradable organic matter by anaerobic bacteria and the mineralization of the soluble organic material in suspension.

1. A device for the treatment of rain water comprising an enclosure (4) adapted to be inserted vertically into a sump-separator (1), said sump-separator (1) comprising a water inlet (2) and a water outlet (12), characterized in that a portion of the lateral wall of the enclosure (4) is at least partially curved and that said portion comprises a filter (5), the inside of the enclosure (4) being formed by a first cavity (6) and a second cavity (8) separated by a vertical wall (9) but communicating with one another by means of a passage (15) created in the lower portion of the enclosure (4), the first cavity (6) having said filter (5) as its outer lateral wall, the second cavity (8) comprising an outlet orifice suitable for communicating directly, via a discharge tube (7), with said water outlet (12) of the sump-separator (1).

2. The device as claimed in claim 1, wherein said enclosure (4) has a cylindrical shape.

3. The device as claimed in claim 1, wherein said enclosure (4) comprises a gripping member (11) placed on its upper portion.

4. The device as claimed in claim 1, wherein the filter (5) is removable.

5. The device as claimed in claim 1, wherein the filter (5) is coalescing.

6. The device as claimed in claim 1, comprising a supernatant trap (16) placed between the outer walls of said cavities (6, 8) and the inner wall of the sump-separator (1).

7. An assembly consisting of a device as claimed in claim 1, and a sump-separator (1) in which said water inlet (2) comprises an inlet chicane (3, 13) created so that the incoming water flows into the sump-separator (1) in a substantially horizontal direction.

8. The assembly consisting of a device as claimed in claim 1, and a sump-separator (1), the latter comprising a discharge tube (7), characterized in that the enclosure (4) is mounted suspended on the discharge tube (7).

9. The assembly as claimed in claim 8, wherein the discharge tube (7) comprises means for taking samples.
